(19) United States
(12) Patent Application Publication
(10) Pub. No.: US 2005/0158020 A1
(43) Pub. Date: Jul. 21, 2005

(54) Data archiving apparatus for a security system and method thereof

(75) Inventor: Sang-Wook Park, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/010,409

(22) Filed: Dec. 14, 2004

(30) Foreign Application Priority Data
Jan. 17, 2004 (KR) 2004-3605

(51) Int. Cl. H04N 5/76; G11B 27/00

(52) U.S. Cl. 386/52; 386/125

(57) ABSTRACT

An archiving apparatus and method for use with security system archives for externally-received video and audio signals, having a magnetic tape archive for recording the video and audio signals onto a magnetic tape, a hard disc drive (HDD) archive for recording the video and audio signals onto a hard disc drive (HDD), a selection unit for transmitting a HDD archive selection signal, or transmitting a magnetic tape archive selection signal if an error occurs, or for a data is full occurrence in the HDD, and a central processing unit for recording the video and audio signals in one of the magnetic tape archive and the HDD archive in accordance with the selection signal received from the selection unit.

### PRIORITY

This application claims the benefit under 35 U.S.C. 119(a) of Korean Patent Application No. 2004-03605 filed Jan. 17, 2004, in the Korean Intellectual Property Office, the entire contents of which is incorporated herein by reference.

### BACKGROUND OF THE INVENTION

1. Field of the Invention

The present invention relates to a data archiving apparatus and method for use with a security system. More particularly, the present invention relates to a data archiving apparatus and method for use with a security system, which combines therein a first archive using a hard disc drive and a second archive using magnetic tape, and records on the magnetic tape when it is not possible to record on the hard disc drive so as to ensure stable archiving of the security system.

2. Description of the Related Art

Generally, a security system receives video signals from remote areas through at least one visual surveillance camera and displays the received signals through a screen, enabling users to monitor the remote area from the center station on a real-time basis. Additionally, the security system generally provides an archiving function, which stores the video signals captured by the camera to a provided storage medium as backup data for the users to review at a later time.

Conventional archiving apparatuses usually perform data storage with a digital video recorder.

FIG. 1 is a block diagram showing one of the recent archiving apparatuses for use with the conventional security system. Referring to FIG. 1, the general archiving apparatus includes a signal processor 10, a hard disc drive archive 20 and a central processing unit 50.

The signal processor 10 includes a video signal processor 15 and an audio signal processor 17. The video signal processor 15 receives video signals captured through the remote cameras, and perform processes such as video decoding and compression. The audio signal processor 17 performs analog-to-digital conversion with respect to the received audio signal.

The hard disc drive archive 20 synchronizes the audio signal processed at the audio signal processor 17 to the video signal processed at the video signal processor 15, and records the data in the hard disc drive.

The central processing unit 50 controls the signal processor 10 and the hard disc drive archive 20 so that video and audio signals can be properly recorded in the hard disc drive.

However, the conventional archiving has a shortcoming in that the archiving process is not possible when there is no memory space available in the hard disc drive.

In order to solve the problem related with the limited archiving as mentioned above, it has been proposed that new data be overwritten on the oldest data recorded in the hard disc drive. However, because the existing data have to be deleted, data loss occurs.

The method of using the hard disc drive also has the shortcoming that data archiving is not allowed when there is an error in the hard disc drive, or when the hard disc drive is removed by malice. Accordingly, the performance of the security system deteriorates.

### SUMMARY OF THE INVENTION

Accordingly, the present invention has been made to solve the above-mentioned and/or problems, and an aspect of the present general inventive concept is to provide an archiving apparatus and method for use with a security system, which is capable of storing backup data not only in a hard disc drive but also in a magnetic tape such that when it is impossible to record the data in the hard disc drive due to problems such as error, full data and removal of the hard disc drive, the data archiving is performed with respect to the magnetic tape and therefore, stable archiving can be guaranteed.

The above aspects and/or other features of the present invention can substantially be achieved by providing an archiving apparatus for use with a security system, which archives externally-received video and audio signals. The archiving apparatus comprise a magnetic tape archive for recording the video and audio signals onto a magnetic tape, a hard disc drive (HDD) archive for recording the video and audio signals onto a hard disc drive (HDD), a selection unit for transmitting a HDD archive selection signal, or transmitting a magnetic tape archive selection signal if an error occurs, or if data is full in the HDD, and a central processing unit for recording the video and audio signals on one of the magnetic tape archive and the HDD archive in accordance with the selection signal received from the selection unit.

The HDD archive comprises a hard disc drive (HDD) rack with which the HDD can be attached and detached, and the selection unit transmits the magnetic tape archive selection signal in accordance with the detachment of the HDD.

The selection unit may apply a LOW logic level to the central processing unit in accordance with the magnetic archive selection signal, and apply a HIGH logic level to the central processing unit in accordance with the HDD archive selection signal. The central processing unit may apply a HIGH logic level to the HDD in accordance with the LOW logic level to activate the HDD, and control the HDD archive such that the video and audio signals are recorded onto the HDD, and control the magnetic tape archive in accordance with the HIGH logic level so that the video and audio signals are recorded in the magnetic tape.

According to an aspect of the present invention, an archiving method is provided. More specifically, in a security system which comprises a magnetic tape archive for storing externally-received video and audio signals in a magnetic tape, and a hard disc drive (HDD) archive for storing the externally-received video and audio signals in a hard disc drive (HDD). The archiving method comprises the steps of transmitting a HDD archive selection signal, or transmitting a magnetic tape archive selection signal in the event of an error occurrence or data full of the HDD, and recording the video and audio signals to one of the magnetic tape archive and the HDD archive which corresponds to the selection signal.

The HDD archive comprises a hard disc drive (HDD) rack with which the HDD can be attached and detached, and the step of transmitting a HDD archive selection signal comprises transmitting the magnetic tape archive selection signal in accordance with the detachment of the HDD.

### BRIEF DESCRIPTION OF THE DRAWINGS

The above aspects and features of the present invention will be more apparent by describing certain embodiments of the present invention with reference to the accompanying drawings, in which:

FIG. 1 is a block diagram of an archiving apparatus for use with a conventional security system;

FIG. 2 is a block diagram of an archiving apparatus for use with a security system according to an embodiment of the present invention;

FIG. 3 is a block diagram of an archiving of a magnetic tape of FIG. 2;

FIG. 4 is a block diagram of an archiving of a hard disc drive of FIG. 2; and

FIG. 5 is a flowchart illustrating the operation of an archiving apparatus for use with a security system according to an embodiment of the present invention.

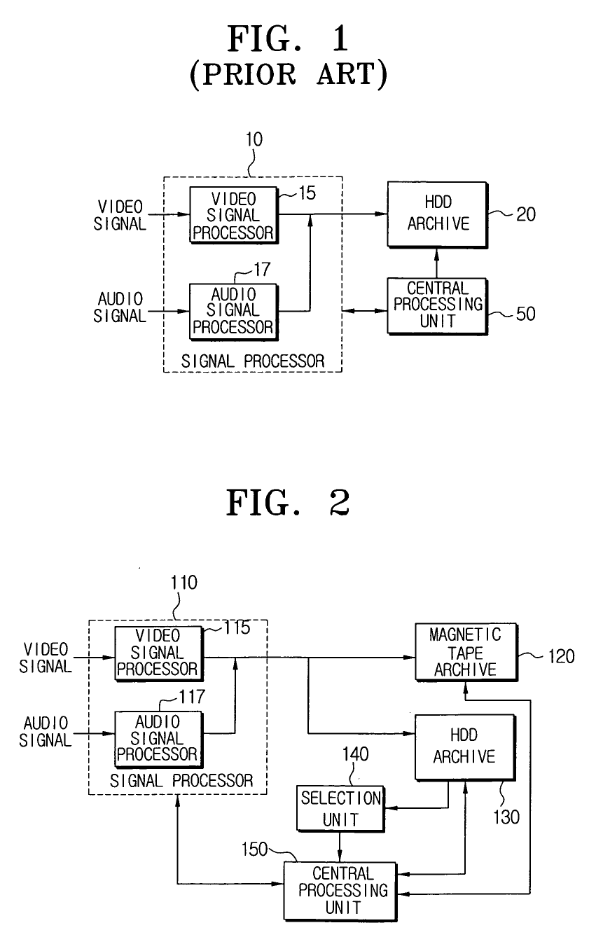

### DETAILED DESCRIPTION OF THE PREFERRED EMBODIMENTS

Certain embodiments of the present invention will be described in greater detail with reference to the accompanying drawings.

In the following description, the same drawing reference numerals are used for the same elements even in different drawings. The examples provided in the description such as a detailed construction and elements are provided to assist in understanding the invention. Thus, it should be apparent that the present invention can be performed without those defined matters. Also, well-known functions or constructions are not described in detail for conciseness.

FIG. 2 is a block diagram of an archiving apparatus for use with a security system according to an embodiment of the present invention. Referring to FIG. 2, an archiving apparatus according to an embodiment of the present invention includes a signal processor 110, a magnetic tape archive 120, a hard disc drive archive 130, a selection unit 140 and a central processing unit 150.

The signal processor 110 includes a video signal processor 115 and an audio signal processor 117. The video signal processor 115 receives video signals captured by the remote cameras, and performs processes such as video decoding and compression. The audio signal processor 117 performs analog-to-digital conversion with respect to the received audio signal.

The magnetic tape archive 120 synchronizes audio signals to the video signal which is processed by the signal processor 110, and records the signals in the magnetic tape. The magnetic tape archive 120 is a conventional video cassette recorder, which is externally provided. The magnetic tape archive 120 may be constructed to communicate with the archive apparatus of the main body of the security system via an external input/output interface (not shown).

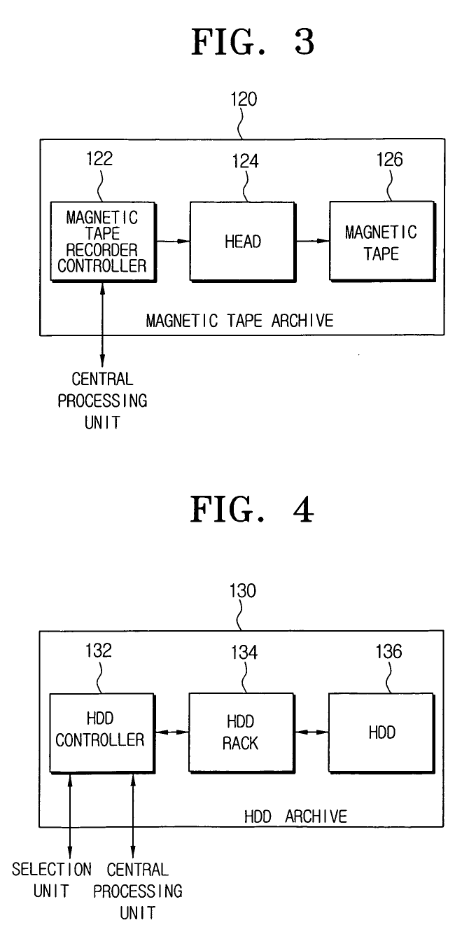

FIG. 3 is a block diagram of the magnetic tape archive 120. The magnetic tape archive 120 includes a head 124, a removable magnetic tape 126 and a magnetic tape recorder controller 122.

There are heads for recording and reproducing in the head 124, and the head 124 operates to read data from the magnetic tape 126, and magnetically record video and audio signals processed by the signal processor 110 onto the magnetic tape 126.

The magnetic tape recorder controller 122 controls the head 124 so that data can be recorded and reproduced with respect to the magnetic tape 126, and communicates with the central processing unit 150 which will be described in greater detail below. When the selection signal with respect to the magnetic tape archive 120 is received, the processed video and audio signals are recorded in the magnetic tape 126. The data recording may be performed in a video home system (VHS) format.

The hard disc drive archive 130 synchronizes the video signal processed by the video signal processor 115, to the audio signal processed by the audio signal processor 117, and records the signal in the hard disc drive.

FIG. 4 is a block diagram of the hard disc drive archive 130. Referring to FIG. 4, the hard disc drive (HDD) archive 130 includes a hard disc drive (HDD) rack 134, a hard disc drive (HDD) 136 and a hard disc drive (HDD) controller 132.

The HDD rack 134 is a structure which the HDD 136 is attached to and detached from. The HDD 136 records therein video and audio signals which are processed by the signal processor 110. The HDD controller 132 communicates with the central processing unit 150 such that the video and audio signals can be synchronized and recorded onto the HDD 136. The HDD controller 132 detects when an error occurs in the HDD 136, when the HDD 136 is full with data, and when the HDD 136 is removed from the HDD rack 134, and provides the detected result to the selection unit which will be described in detail below.

The selection unit 140 selects one of the HDD archive 130 and the magnetic tape archive 120 to perform data archiving with video and audio signals, and transmits to the central processing unit 150.

In more detail, when the HDD archive 130 operates in normal condition, a HDD archive selection signal is transmitted so that recording can be performed with respect to the HDD archive 130, and when an abnormality occurs, such as an error, full data, or removal of the HDD 136, a magnetic tape archive selection signal is transmitted so that the video and audio signals processed by the signal processor 110 can be performed with respect to the magnetic tape 126 of the magnetic tape archive 120.

The central processing unit 150 controls the signal processor 110, the magnetic tape archive 120 and the HDD archive 130 to perform data archiving of the security system, and particularly, controls such that the video and audio signals can be archived in the magnetic tape archive 120 or in the HDD archive 130 in accordance with the selection signal received from the selection unit 140.

When the HDD archive 130 is selected, the selection unit 140 may transmit a LOW logic level to the central processing unit 150, and when the magnetic tape archive 120 is selected, a HIGH logic level may be transmitted to the central processing unit 150.

Accordingly, the central processing unit 150 applies a HIGH logic level to the HDD 136 in response to the input of LOW logic level, activates the HDD 136, and controls the HDD controller 132 so that the HDD archive 130 can perform archiving of video and audio signals. Also, the central processing unit 150 controls the magnetic tape recorder controller 122 so that the magnetic tape archive 120 can perform archiving in response to the HIGH logic level.

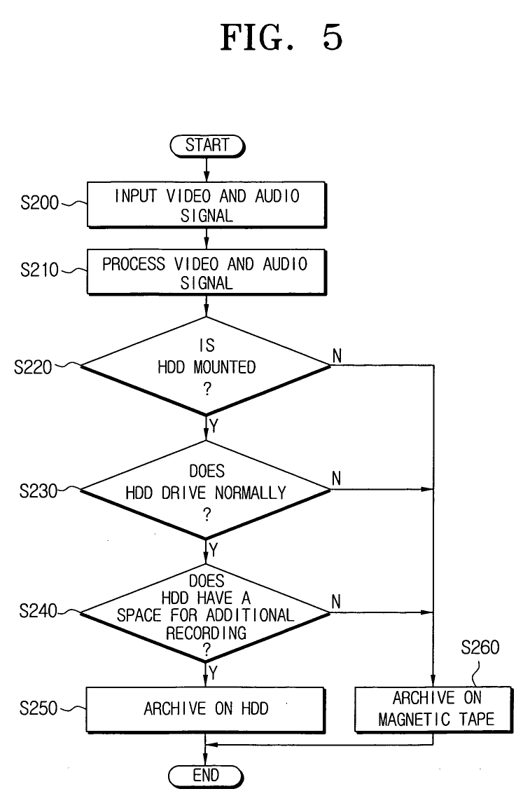

FIG. 5 is a flowchart illustrating the operation of the archiving apparatus for use with the security system according to an embodiment of the present invention.

With reference to FIGS. 2 to 5, the signal processor 110 of the archiving apparatus first receives video and audio signals from the remote security camera or microphone at step S200. And then video processing such as decoding and compressing, and audio processing such as analog-to-digital converting, are performed at step S210.

In order to archive video and audio signals respectively processed, the selection unit 140 confirms whether the HDD 136 is mounted to the HDD rack 134 at step S220. If so, it is determined whether the HDD 136 operates normally at step S230. When the HDD 136 operates normally, it is checked as to whether there is memory space available in the HDD 136 at step S240.

Accordingly, when it is confirmed that the HDD 136 is mounted, operating without errors, and that there is sufficient memory space for additional data storage through steps S220 to S240, the selection unit 140 transmits a HDD archive selection signal to the central processing unit 150.

The central processing unit 150 archives video and audio signals, processed at step S210, to the HDD archive 130 in accordance with the HDD archive selection signal at step S250.

If any of the above-mentioned condition is not met in steps S220 to S240, the selection unit 140 transmits a magnetic tape archive selection signal, and accordingly, the central processing unit 150 archives the video and audio signals of S210 onto the magnetic tape 126 through the magnetic tape archive 120 at step S260.

As described above, data archiving can be performed safely onto the magnetic tape 126 when the HDD 136 archiving is impossible.

Accordingly, when abnormal situation arises, such as when an error occurs or when the data is full in the HDD, or when the HDD is removed unexpectedly, data can be safely stored on the magnetic tape 126, and therefore, data loss can be prevented even when the HDD archiving is not possible. As a result, the efficiency of the security system improves.

Additionally, because the magnetic tape 126 is quite economical and is readily available, user convenience also improves.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations should be apparent to those skilled in the art.

1. An archiving apparatus for use with a security system, which archives externally-received video and audio signals, the archiving apparatus comprising:
a magnetic tape archive for recording the video and audio signals onto a magnetic tape;
a hard disc drive (HDD) archive for recording the video and audio signals onto a hard disc drive (HDD);
a selection unit for transmitting a HDD archive selection signal, or transmitting a magnetic tape archive selection signal if an error occurs, or if data is full in the HDD; and
a central processing unit for controlling recordation of the video and audio signals in one of the magnetic tape archive and the HDD archive in accordance with the selection signal received from the selection unit.

2. The archiving apparatus of claim 1, wherein the HDD archive comprises a hard disc drive (HDD) rack with which the HDD can be attached and detached, and the selection unit transmits the magnetic tape archive selection signal in accordance with the detachment of the HDD.

3. The archiving apparatus of claim 1, wherein the selection unit applies a LOW logic level to the central processing unit in accordance with the magnetic archive selection signal, and applies a HIGH logic level to the central processing unit in accordance with the HDD archive selection signal, and
the central processing unit applies a HIGH logic level to the HDD in accordance with the LOW logic level to activate the HDD, and controls the HDD archive such that the video and audio signals are recorded onto the HDD, and controls the magnetic tape archive in accordance with the HIGH logic level so that the video and audio signals are recorded onto the magnetic tape.

4. An archiving method for use in a security system which comprises a magnetic tape archive for storing externally-received video and audio signals onto a magnetic tape, and a hard disc drive (HDD) archive for storing the externally-received video and audio signals onto a hard disc drive (HDD), the archiving method comprising the steps of:
transmitting a HDD archive selection signal, but transmitting a magnetic tape archive selection signal in the event of an error occurrence or data full occurrence of the HDD; and
recording the video and audio signals to one of the magnetic tape archive and the HDD archive which corresponds to the selection signal.

5. The archiving method of claim 4, wherein the HDD archive comprises a hard disc drive (HDD) rack with which the HDD can be attached and detached, and the step of transmitting a HDD archive selection signal comprises transmitting the magnetic tape archive selection signal in accordance with the detachment of the HDD.
